(19) United States
(12) Patent Application Publication
(10) Pub. No.: US 2010/0058426 A1
(43) Pub. Date: Mar. 4, 2010

(54) ATSC SIGNAL RECORDER/PROCESSOR

(75) Inventors: Fredrik Carpio, San Diego, CA (US); Nikolaos Georgis, San Diego, CA (US)

Correspondence Address: ROGITZ & ASSOCIATES, 750 B STREET, SUITE 3120, SAN DIEGO, CA, 92101, US

(73) Assignee: SONY CORPORATION AND SONY ELECTRONIC INC.

(21) Appl. No.: 12/204,264

(22) Filed: Sep. 4, 2008

(51) Int. Cl. H04N 7/173

(52) U.S. Cl. 725/131

(57) ABSTRACT

ATSC TV signals are monitored for user-defined search terms and content, including both audio-video and non-audio-video content, is recorded when header tags in the files are determined to match the terms.

### FIELD OF THE INVENTION

The present invention relates generally to recording and processing Advanced Television Systems Committee (ATSC) signals.

### BACKGROUND OF THE INVENTION

ATSC establishes a standard for digital TV signals. As understood herein, digital TV poses opportunities for distribution of data, not just audio-video streams, that heretofore has not been envisioned.

### SUMMARY OF THE INVENTION

A device is configured to receive digital TV signals bearing plural files, and to monitor the files for matches to user-defined terms. The device is also configured to record at least one file in the digital TV signals in response to determining that at least one match occurred.

In some embodiments the device tests header tags in files against the user-defined terms to determine whether a match has occurred. If desired, the device can be configured to present, on a TV, a list of A/V files recorded by the device but not including computer applications recorded by the device. On the other hand, the device can present a list including computer applications to a user computer. The user-defined terms can be input by a user manipulating a TV remote control and the digital TV signals can be Advanced Television Systems Committee (ATSC) signals.

In another aspect, a tangible computer storage medium is readable by a processor to receive digital TV signals, record files in the signals in response to a user command without requiring the user to designate a recording time or channel, and present a list of recorded files to a computerized apparatus.

In another aspect, a method includes receiving digital TV signals bearing audio-video files and non-audio-video files. The method also includes receiving at least one user command indicating at least one name of a file sought to be recorded but not indicating broadcast times. The method contemplates recording at least one received file in the TV signals if header information in the received file matches at least one term in the user commands.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a schematic view of a non-limiting system in accordance with present principles;

FIG. 2 is a schematic view of a simplified file structure; and

FIG. 3 is a flow chart of non-limiting logic which maybe undertaken by one or more processors executing code elements stored on one or more computer readable media.

### DETAILED DESCRIPTION OF THE PREFERRED EMBODIMENT

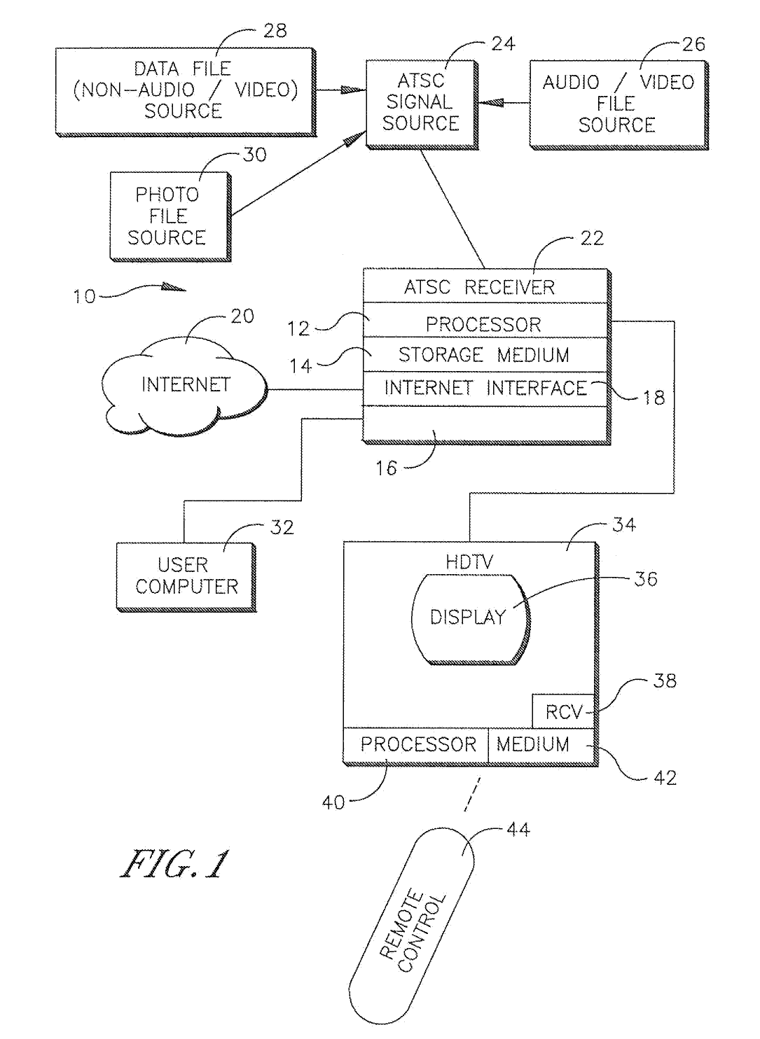

Referring initially to FIG. 1, a device is shown, generally designated 10, that includes a processor 12 and tangible digital storage medium 14 that may be, without limitation, a magnetic or optical disk drive, a solid state device such as random access memory or read-only memory or flash memory, a removable stick medium or removable floppy disk, etc. The medium 14 and processor 12 may be stored in a housing 16.

As shown in FIG. 1, in some embodiments the device 10 may further include a communications interface 18 such as but not limited to a wired or wireless modem or transceiver configured to communicate, via the Internet 20, with other computers. In any case, the device 10 may also include an ATSC receiver 22 for receiving digital television signals from an ATSC signal source 24 such as, e.g., a cable head end, an antenna, etc. which receives audio-video files representing digital TV programming from an A/V file source 26. The ATSC signal source 24 may also receive non-A/V files such as computer applications from a data file source 28, and digital still photograph files from a photo file source 30. Other sources of information may feed the ATSC signal source 24, which can send the files it receives in a televised signal.

As shown in FIG. 1, the device 10 may communicate with a user computer 32 such as a laptop computer that can include a computer processor, storage medium, one or more input devices such as mice and keypads, and one or more output devices such as a computer monitor. Additionally, the device 10 may communicate with other devices such as a cell phone, camera, game console, etc. for sending information to the devices in accordance with disclosure below.

One of the other devices with which the device 10 can communicate typically is a digital TV 34 which may include a display 36 such as a high definition display. The TV 34 can also include a signal receiver 38 such as a TV tuner, a TV processor 40 controlling the TV, and a data storage medium 42 accessed by the TV processor 40. The processor 40 may receive user commands from a wireless remote control 44 and the TV processor 40 may communicate and cooperate with the processor 12 of the device 10.

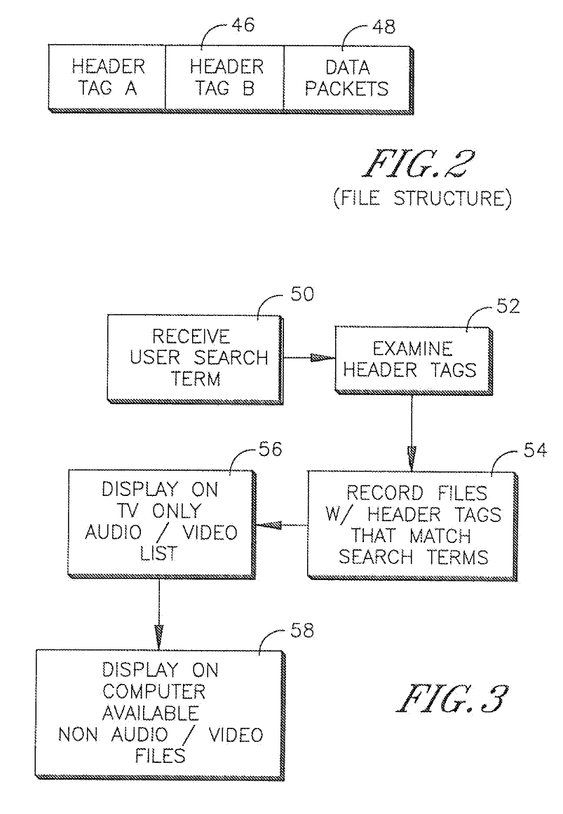

FIG. 2 shows that files received from the ATSC signal source 24 by the device 10 may include, among other data elements, one or more header tags 46 followed by data packets 48. The header tags 46 may identify the content of the data packets 48, e.g., a header tag may indicate “Spiderman movie” indicating that the data packets establish an audio-video stream titled “Spiderman”. As another example, the header tags 46 may indicate “John's photos” indicating that the data packets establish one or more digital still photos with the tithe “John”. Yet again, the header tags may indicate “ABC Word Processing application” indicating that the data packets establish a computer application of a particular name/type that can be executed by a computer processor.

FIG. 3 shows that at block 50, the device 10 can receive user search terms indicating user-desired content to be recorded on, e.g., the medium 14. The search terms may be received in various non-limiting ways, such as by presenting a user interlace on the TV 34 instructing the user to input, by means of the remote control 44, the tithes of content or other data files desired by the user. For instance, the user might input “Gone With the Wind”, indicating a desire to record the movie by that name. The user might also input “ABC Word Processor” indicating a desire to obtain the computer application by that name.

Proceeding to block 52, the header tags of all files received on various channels from the ATSC signal source 24 are examined and if matches are found between the header tags and the search terms (within, if desired, one or more predetermined matching criteria), the associated files are recorded at block 54. In the example above, the user need not have instructed the device 10 to record any particular channel at any particular time, but only to record the A/V file “Gone with the Wind” at such time as the file is sent in the ATSC signal regardless of channel; likewise, as soon as the requested computer application is received, it is recorded.

Subsequently, the user may be presented with a user interface on the TV 34 listing the recorded A/V files. However, content stored on the medium 14 such as computer applications that have no relevance to the TV are not listed on the TV, relieving the user of sorting through extraneous listings that cannot be displayed on the TV. A user may select a file in the list for playing on the TV using the remote control.

On the other hand, at block 58 the user may log on to the user computer 32 and access the device 10. In this case, the device 10 sends a list of content to the user computer 32 that is relevant to the computer, and a user can select one or more files on the list for copying, execution, playing, etc. For example, the user computer might be configured to both display A/V content, and thus be presented with a list of A/V files recorded on the device 10, as well as execute computer applications, in which case a list of recorded applications on the device 10 such as the above-discussed word processor is presented for display on the user computer. Other content from the ATSC signal source 24 recorded by the device 10 pursuant to the user's commands might also be listed on the user computer 32. The user may then transfer content, play content, view content, etc. at any time convenient for the user.

While the particular ATSC SIGNAL RECORDER/PROCESSOR is herein shown and described in detail, it is to be understood that the subject matter which is encompassed by the present invention is limited only by the claims.

What is claimed is:

1. A device that:
is configured to receive digital TV signals bearing plural files;
is configured to monitor the files for matches to user-defined terms; and
is configured to record at least one file in the digital TV signals in response to determining that at least one match occurred.

2. The device of claim 1, wherein the device tests header tags in files against the user-defined terms to determine whether a match has occurred.

3. The device of claim 1, wherein the device is configured to present, on a TV, a list of A/V files recorded by the device but not including computer applications recorded by the device.

4. The device of claim 1, wherein the device is configured to present a list including at least computer applications to a user computer.

5. The device of claim 1, wherein the user-defined terms are input by a user manipulating a TV remote control.

6. The device of claim 1, wherein the digital TV signals are Advanced Television Systems Committee (ATSC) signals.

7. A tangible computer storage medium readable by a processor to:
receive digital TV signals;
record files in the signals in response to a user command without requiring the user to designate a recording time or channel; and
present a list of recorded files to a computerized apparatus.

8. The medium of claim 7, wherein the apparatus is a user computer and the files include at least one computer application.

9. The medium of claim 7, wherein the apparatus is a TV and the list presents titles of A/V content that has been recorded in response to the user command but not computer applications that have been recorded in response to the user command.

10. The medium of claim 7, wherein the processor monitors the files for matches to user-defined terms.

11. The medium of claim 10, wherein the device tests header tags in files against the user-defined terms to determine whether a match has occurred.

12. The medium of claim 10, wherein the user-defined terms are input by a user manipulating a TV remote control.

13. The medium of claim 7, wherein the digital TV signals are Advanced Television Systems Committee (ATSC) signals.

14. A method comprising:
receiving digital TV signals bearing audio-video files and non-audio-video files;
receiving at least one user command indicating at least one name of a file sought to be recorded but not indicating broadcast times; and
recording at least one received file in the TV signals if header information in the received file matches at least one term in the user commands.

15. The method of claim 14, wherein the digital TV signals are Advanced Television Systems Committee (ATSC) signals.

16. The method of claim 14, comprising presenting a list on the TV of only recorded files that can be presented on the TV and not presenting in the list names of other recorded files.

17. The method of claim 14, wherein the header information is contained in header tags associated with the files.

18. The method of claim 14, comprising presenting a list including at least recorded computer applications received in the TV signals to a user computer.

19. The method of claim 14, wherein the user command is input by a user manipulating a TV remote control.
